(19) United States
(12) Patent Application Publication
(10) Pub. No.: US 2008/0094944 A1
(43) Pub. Date: Apr. 24, 2008

(54) Method of controlling th ewriting power of a laser beam and optical recorder

(75) Inventors: Joris Huibert Joseph Geurts, Eindhoven (NL); Hendrikus Albertus Johanna Looijmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,580

(22) PCT Filed: Aug. 16, 2005
(86) PCT No.: PCT/IB05/52698

§ 371 Date: Feb. 12, 2007

(30) Foreign Application Priority Data
Aug. 19, 2004 (EP) 04103979.3

(51) Int. Cl. G11B 31/00

(52) U.S. Cl. 369/19

(57) ABSTRACT

A method of controlling the writing power of a laser beam in an optical recorder and an optical recorder having means for controlling the writing power of the laser beam are provided. The invention is directed to a Walking Optimum Power Control (Walking OPC) during writing onto an optical storage medium having two storage layers. The method comprises the steps of: incrementing a first counter (20) when a writing power control is performed with respect to a writing operation onto the first storage layer (16); incrementing a second counter (22) when a writing power control is performed with respect to a writing operation onto the second storage layer (18); calculating a first waiting time between two writing power control operations with respect to the first storage layer (16) under consideration of the first counter (20); and calculating a second waiting time between two writing power control operations with respect to the second storage layer (18) under consideration of the second counter (22).

### FIELD OF THE INVENTION

The present invention relates to a method of controlling the writing power of a laser beam during writing of data onto an optical storage medium. Particularly, the present invention relates to a method of controlling the writing power during writing onto an optical storage medium having at least two storage layers. The present invention further relates to an optical recorder.

### BACKGROUND OF THE INVENTION

Optical recording is generally achieved by directing a beam of laser light onto a record carrier, the laser power being adjusted so as to be able to change the reflecting properties of the record carrier surface. It is required that during writing marks on the surface, the writing power is properly set. Particularly, the writing power has to be adjusted in order to maintain a particular target asymmetry. This asymmetry is often referred to as β. The calculation of β as a function of the laser power is described in detail in U.S. Pat. No. 5,303,217. It is also possible to use different definitions of the asymmetry signal.

It is not only required to perform an Optimum Power Control (OPC) at the beginning of a writing process but also during writing. The so-called Walking OPC calibration as disclosed in WO 03/065357 A 2 adapts the writing power at different instances during the writing process. This has to be performed frequently at the beginning of the writing process and less frequently when the writing process progresses due to the heating-up process of the laser. The output power of the laser is sensitive to the temperature of the laser, so in the beginning the laser is heating up from ambient temperature to operational temperature. It is desired to reduce the frequency of calibrations during the writing process in order to reduce the overall recording time.

According to prior art, the time between two Optimum Power Control processes is calculated by a software counter that is incremented each time when an Optimum Power Control is performed. Thus, the controller of the optical recorder is aware of the progress of the writing process and is therefore able to calculate an appropriate interwalking OPC time in dependence on the counter value.

In order to increase the amount of data that can be stored on an optical disc, the double-layer DVD+R disc was developed. Adding a second storage layer to a record carrier that can be accessed from the same side of the disc as the first storage layer provides the possibility to increase the data storage capacity.

For such double-layer systems the prior art calculation of the interwalking OPC time is not satisfying, particularly due to the time difference between writing on the first layer and the second layer. An interwalking OPC time that is suitable for writing on the first layer is not necessarily satisfying for a writing process to the second layer and vice versa.

It is an object of the invention to provide a method and an optical recorder so that a Walking Optimum Power Control can be satisfyingly performed with respect to both storage layers.

### SUMMARY OF THE INVENTION

The above objects are solved by the features of the independent claims. Further developments and preferred embodiments of the invention are outlined in the dependent claims.

In accordance with the present invention, there is provided a method of controlling the writing power of a laser beam during writing of data onto an optical storage medium having at least a first storage layer and a second storage layer, comprising the steps of incrementing a first counter when a writing power control is performed with respect to a writing operation onto the first storage layer;

incrementing a second counter when a writing power control is performed with respect to a writing operation onto the second storage layer;

calculating a first waiting time between two writing power control operations with respect to the first storage layer under consideration of the first counter; and

calculating a second waiting time between two writing power control operations with respect to the second storage layer under consideration of the second counter.

As mentioned, according to prior art, a single software counter is provided in order to calculate the time between two subsequent Optimum Power Control calibrations. According to the invention, an additional software counter is provided for counting the Walking Optimum Power Control processes that are performed with respect to the second storage layer. Thus, the interwalking OPC time is calculated independently for both recording layers and therefore a target asymmetry can be maintained satisfyingly with respect to both layers. The method of the present invention is not limited to double-layer recording. Rather, multiple-layer recording requires an additional counter for each additional storage layer.

Preferably, the waiting time between two writing power control operations increases with an increase of the corresponding counter value. This corresponds to the prior art experience that the time between two calibrations may increase with progressing recording time. This principle is applied to the calibrations with respect to both of the layers.

Particularly, the waiting time between two writing power control operations is calculated by multiplying the corresponding counter value with a constant value. This is a simple software step that leads to satisfying results.

Preferably, the method according to the invention comprises the steps of:

determining on which storage layer writing operations are presently performed;
if writing operations are performed on the first storage layer,
   performing a writing power control with respect to the first storage layer,
   incrementing the first counter, and
   calculating the first waiting time; and
if writing operations are performed on the second storage layer,
   performing a writing power control with respect to the second storage layer,
   incrementing the second counter, and
   calculating the second waiting time.

As can be seen, the present invention can be implemented by a simple software routine with only minimal effort that is required to modify the prior art system.

Preferably, controlling the writing power of the laser beam is performed as a Walking Optimum Power Control (Walking OPC) on the basis of an asymmetry value β determined from the reflected laser beam. The calibration of the writing power during the writing process is particularly useful in order to maintain a target asymmetry. However, the laser power is not only critical with respect to the asymmetry signal but also with respect to more basic properties of the writing process. For example, the laser power has to be adjusted in order to vary the optical properties of the storage layers in a desired manner. Therefore, the present invention is not restricted to a Walking Optimum Power Control on the basis of an asymmetry value but can also be useful with respect to any parameters that have an influence on the writing process. In any case, the individual counter values contain the required information on the number of earlier calibration processes.

The present invention further relates to an optical recorder for writing data onto an optical storage medium having at least a first storage layer and a second storage layer, comprising:

means for controlling the writing power of a laser beam;

a first counter that is incremented when a writing power control is performed with respect to a writing operation onto the first storage layer;

a second counter that is incremented when a writing power control is performed with respect to a writing operation onto the second storage layer;

means for calculating a first waiting time between two writing power control operations with respect to the first storage layer under consideration of the first counter; and

means for calculating a second waiting time between two writing power control operations with respect to the second storage layer under consideration of the second counter.

Thus, the advantages and particular features of the method according to the present invention are also realized with respect to an optical recorder.

These and other aspects of the invention will be apparent from and elucidated with reference to the embodiments described hereinafter.

### BRIEF DESCRIPTION OF THE DRAWINGS

FIG. 1 shows a schematic diagram of an optical recorder according to the present invention; and

FIG. 2 shows a flow chart illustrating a method according to the present invention.

### DESCRIPTION OF PREFERRED EMBODIMENTS

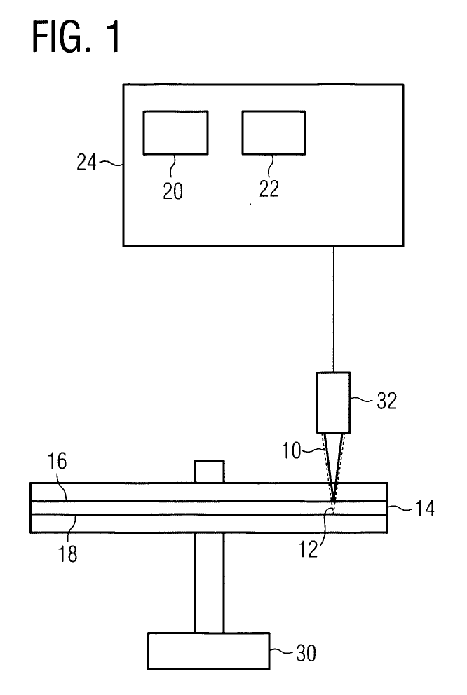

FIG. 1 shows a schematic diagram of an optical recorder according to the present invention. An optical record carrier 14 is driven by a motor 30. The optical record carrier 14 comprises a first optical storage layer 16 and a second optical storage layer 18. From a laser source 32 a laser beam 10, 12 can be focussed on either the first optical storage layer 16 or the second optical storage layer 18. The power of the laser source 32 can be controlled by a controller 24. The controller 24 comprises a first counter 20 and a second counter 22. The operation of the system, and particularly the operation with respect to the first counter 20 and the second counter 22 will be discussed below.

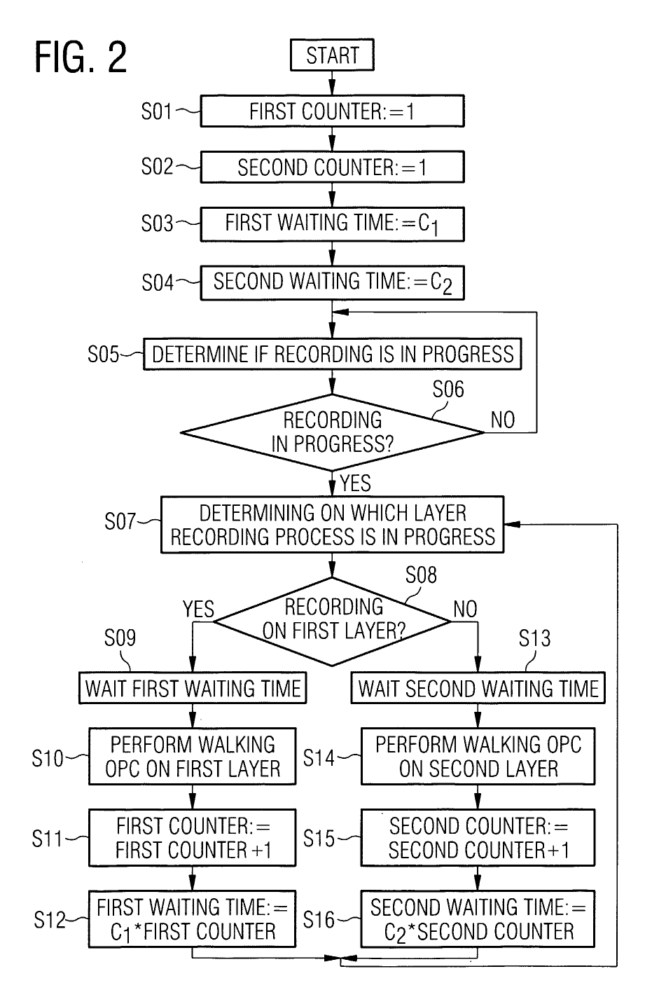

FIG. 2 shows a flow chart illustrating a method according to the present invention. After the start of the system, for example due to the loading of a storage medium into the recorder or due to any other reason, the first counter and the second counter are initialized in step S01 and in S02, respectively. In steps S03 and S04 the first waiting time and the second waiting time, i.e. the time between to subsequent Walking Optimum Power Control (OPC) processes on the first and the second storage layer of the medium, respectively, is set to initial values, namely C₁ and C₂, respectively. After this initializing, in step S05 it is determined, if the recording is in progress. In step S06 it is decided either to proceed to step S07 or to return to the determining step S05. If the recording is not in progress, the flow returns to step S05. Otherwise, in step S07 it is then determined on which layer the recording process is in progress. In step S08 it is decided, whether the recording process presently takes place on the first layer or the second layer. If the recording process takes place on the first layer, the flow waits for the first waiting time (step S09). Then, a Walking Optimum Power Control (OPC) is performed on the first layer (step S10). After step S10 the first counter is incremented (step S11). Then, the waiting time is calculated by multiplying the first counter with the constant C₁ in step S12.

If in step S07 it is decided that the recording process is in progress on the second layer, the flow waits for the second waiting time (step S13). After the waiting time a Walking OPC is performed on the second layer (step S14). Then, the second counter is incremented in step S15. After step S15 the waiting time is calculated by multiplying the second counter by the constant C₂. After calculation of the waiting time in step S12 or in step S16, the process continues in step S07 by determining on which layer the recording process is in progress.

The values C₁ and C₂ can be identical or different, i.e. adapted to the requirements of the individual layers.

The calculation of the waiting time in steps S12 an S16 can be different from the indicated multiplication. Any suitable calculation, identical for both layers or different, may be chosen.

It is noted that the embodiments of the present invention can be different from the examples shown in the drawings and described above. For example, the record carrier may comprise more than two storage layers; in this case, a corresponding number of counters are provided within the controller.

Equivalents and modifications not described above may also be employed without departing from the scope of the invention, which is defined in the accompanying claims.

1. A method of controlling the writing power of a laser beam (10, 12) during writing of data onto an optical storage medium (14) having at least a first storage layer (16) and a second storage layer (18), comprising the steps of:
incrementing a first counter (20) when a writing power control is performed with respect to a writing operation onto the first storage layer (16);
incrementing a second counter (22) when a writing power control is performed with respect to a writing operation onto the second storage layer (18);
calculating a first waiting time between two writing power control operations with respect to the first storage layer (16) under consideration of the first counter (20); and
calculating a second waiting time between two writing power control operations with respect to the second storage layer (18) under consideration of the second counter (22).

2. The method according to claim 1, wherein the waiting time between two writing power control operations increases with an increase of the corresponding counter value.

3. The method according to claim 1, wherein the waiting time between two writing power control operations is calculated by multiplying the corresponding counter value with a constant value.

4. The method according to claim 1, comprising the steps of:
determining on which storage layer (16, 18) writing operations are presently performed;
if writing operations are performed on the first storage layer (16),
performing a writing power control with respect to the first storage layer (16),
incrementing the first counter (20), and
calculating the first waiting time; and
if writing operations are performed on the second storage layer (18),
performing a writing power control with respect to the second storage layer (18),
incrementing the second counter (22), and
calculating the second waiting time.

5. The method according to claim 1, wherein controlling the writing power of the laser beam is performed as a Walking Optimum Power Control (Walking OPC) on the basis of an asymmetry value β determined from the reflected laser beam.

6. An optical recorder for writing data onto an optical storage medium having at least a first storage layer and a second storage layer, comprising:
means (24) for controlling the writing power of a laser beam;
a first counter (20) that is incremented when a writing power control is performed with respect to a writing operation onto the first storage layer (16);
a second counter (22) that is incremented when a writing power control is performed with respect to a writing operation onto the second storage layer (18);
means (24) for calculating a first waiting time between two writing power control operations with respect to the first storage layer (16) under consideration of the first counter (20); and
means (24) for calculating a second waiting time between two writing power control operations with respect to the second storage layer (18) under consideration of the second counter (24).
